(19) United States
(12) Patent Application Publication
(10) Pub. No.: US 2002/0185150 A1
(43) Pub. Date: Dec. 12, 2002

(54) Ultrasonic cleaning method

(75) Inventors: Masahiko Namerikawa, Seto-shi (JP); Kazuyoshi Shibata, Mizunami-shi (JP)

Correspondence Address: BURR & BROWN, PO BOX 7068, SYRACUSE, NY, 13261-7068, US

(73) Assignee: NGK Insulators, Ltd., Nagoya-Shi (JP)

(21) Appl. No.: 10/094,951

(22) Filed: Mar. 11, 2002

(30) Foreign Application Priority Data
Mar. 13, 2001 (JP) 2001-70558

(51) Int. Cl. B08B 3/12

(52) U.S. Cl. 134/1

(57) ABSTRACT

A ultrasonic cleaning method is provided that performs ultrasonic cleaning without breaking a small and low-strength article-to-be-cleaned.

It is a ultrasonic cleaning method that performs ultrasonic cleaning of an article-to-be-cleaned by a combination of a ultrasonic wave transmission medium and particles having a larger specific gravity than the ultrasonic wave transmission medium. The article-to-be-cleaned is cleaned by allowing at least a part of the article-to-be-cleaned to be in contact with a cleaning layer formed with the ultrasonic wave transmission medium and the particles where the mixing ratio of the particles to the ultrasonic wave transmission medium is 10 to 60 vol %, and imparting a ultrasonic wave to the cleaning layer. The particles mutually restrict their movements in a particle group thereby preventing the kinetic energy from becoming excessively large, and exhibit a frictional force and an impinging force suitable for removing the contaminant adhering to the surface without breaking the low-strength article-to-be-cleaned.

### BACKGROUND OF THE INVENTION

1. Technical Field to Which the Invention Belongs

The present invention relates to a ultrasonic cleaning method which is especially effective in cleaning a small and low-strength article-to-be-cleaned such as a small single body or structural body made of ceramics that is inferior in breaking strength or breaking toughness, a single body or structural body made of resin, or a small single body or structural body made of metal that is extremely thin or elongate to have a low strength.

2. Prior Art

A single body or structural body constituting an article-to-be-cleaned of this kind (hereafter these may be abbreviated as articles) are used as a functional component of a precision apparatus or the like or as a constituent member of the functional component, so that its surface must be in an extremely clean and clear state at the time of use. However, in the aforesaid article, during its production process, cuttings and abrasive grains generated at the time of cutting or abrading adhere, or machining oil, cutting oil, processing oil, or the like adheres from a production jig or the like, so that the contamination of its surface is inevitable. For this reason, in the aforesaid article, one must perform an extremely precise cleaning process before its use. As a method of cleaning the aforesaid article or an article similar to this, a ultrasonic cleaning method proposed in Japanese Patent Laid-open Publication No. 09-299893/1997, for example, is known.

The aforesaid ultrasonic cleaning method is a ultrasonic cleaning method that cleans an article-to-be-cleaned by transmitting a ultrasonic wave to a cleaning liquid and, as the cleaning liquid, a cleaning liquid made by uniformly dispersing fine particles in an aqueous solution of a detergent is adopted. The aforesaid ultrasonic cleaning method is a method of cleaning by immersing an article-to-be-cleaned in such a cleaning liquid and imparting a ultrasonic vibration, and the effect of cleaning an article-to-be-cleaned is improved by a synergistic action of a physical peeling force caused by cavitations generated in the aqueous solution of detergent in the cleaning liquid, a chemical cleaning force of the detergent, a frictional force and an impinging force caused by minute vibration of the fine particles, and others.

Meanwhile, in the aforesaid ultrasonic cleaning method, a high cleaning effect on the article-to-be-cleaned can be expected; however, in the case where the article-to-be-cleaned is a small and low-strength article, there is a large fear that the article is broken before being cleaned and cleared because the cavitations generated in the aqueous solution of detergent in the cleaning liquid are excessive and the kinetic energy of the fine particles dispersed in the aqueous solution of detergent is excessive, although the method is extremely effective on an article which has a high strength and is not easily broken as an article-to-be-cleaned.

### SUMMARY OF THE INVENTION

Thus, an object of the present invention is to provide a cleaning method that can clean and clear a small and low-strength article-to-be-cleaned without breaking it.

The present invention relates to a ultrasonic cleaning method which is especially effective in cleaning a small and low-strength article-to-be-cleaned such as a small single body or structural body made of ceramics that is inferior in breaking strength or breaking toughness, a single body or structural body made of resin, or a small single body or structural body made of metal that is extremely thin or elongate to have a low strength. It is a ultrasonic cleaning method that performs ultrasonic cleaning of an article-to-be-cleaned by a combination of a ultrasonic wave transmission medium transmitting a ultrasonic wave to a predetermined region and particles having a larger specific gravity than the ultrasonic wave transmission medium.

Now, the first ultrasonic cleaning method according to the present invention is characterized in that the aforesaid article-to-be-cleaned is cleaned by allowing at least a part of the article-to-be-cleaned to be in contact with a cleaning layer formed with the aforesaid ultrasonic wave transmission medium and the aforesaid particles where the mixing ratio of the particles to the aforesaid ultrasonic wave transmission medium is 10 to 60 vol %, and imparting a ultrasonic wave to the cleaning layer.

Further, the second ultrasonic cleaning method according to the present invention is characterized in that a cleaning layer formed with the aforesaid ultrasonic wave transmission medium and the aforesaid particles and a contamination absorbing layer such that a ratio of the aforesaid particles to the aforesaid ultrasonic wave transmission medium is lower than in the aforesaid cleaning layer are adopted as cleaners, and the aforesaid article-to-be-cleaned is cleaned by allowing at least a part of the article-to-be-cleaned to be in contact with the aforesaid cleaning layer of the cleaners, and imparting a ultrasonic wave to the cleaning layer.

In the second ultrasonic cleaning method according to the present invention, it is preferable that a mixing ratio of the aforesaid particles to theaforesaid ultrasonic wave transmission medium in the aforesaid cleaning layer is 10 to 60 vol %, and that a mixing ratio of the aforesaid particles to the aforesaid ultrasonic wave transmission medium in the aforesaid contamination absorbing layer is 0.001 vol % or less.

Further, in the first and second ultrasonic cleaning methods according to the present invention, it is preferable that particles such that a ratio of (specific gravity of article-to-be-cleaned)/(specific gravity of particles) is within a range from 0.5 to 3 are adopted as the aforesaid particles, that the aforesaid particles are particles of an inorganic series substance or an organic series polymer substance, and that the aforesaid particles are particles having an average particle diameter of 0.1 μm to 500 μm, and further it is preferable that the aforesaid ultrasonic wave transmission medium is a cleaning liquid.

Basically, each of the ultrasonic cleaning methods according to the present invention performs ultrasonic cleaning of an article-to-be-cleaned by allowing at least a part of the article-to-be-cleaned to be in contact with or to be substantially buried in a cleaning layer formed with a ultrasonic wave transmission medium and particles.

In the aforesaid ultrasonic cleaning method, the particles constituting the cleaning layer are vibrated by transmitting a ultrasonic wave to the particles via the ultrasonic wave transmission medium constituting the cleaning layer, and the article-to-be-cleaned is cleaned and cleared by using a frictional force and an impinging force caused by the vibration of the particles.

In such ultrasonic cleaning, the particles in the cleaning layer mutually restrict their movements thereby preventing the kinetic energy of the particles from becoming excessively large, and the article-to-be-cleaned is effectively cleaned and cleared by cleaning the article-to-be-cleaned with a frictional force and an impinging force suitable for removing the contaminant adhering to the surface of the article-to-be-cleaned without breaking the low-strength article-to-be-cleaned.

The cleaning layer adopted in each of the ultrasonic cleaning methods according to the present invention is preferably such that a mixing ratio of the particles to the ultrasonic wave transmission medium is from 10 to 60 vol %. In the aforesaid cleaning layer, if the mixing ratio of the particles is less than 10 vol %, the kinetic energy of the particles caused by the ultrasonic wave becomes too large thereby causing breakage of the article-to-be-cleaned, whereas if the mixing ratio of the particles exceeds 60 vol %, the kinetic energy of the particles caused by the ultrasonic wave becomes too small thereby providing insufficient cleaning of the article-to-be-cleaned.

Further, in each of the ultrasonic cleaning methods according to the present invention, particles such that a ratio of (specific gravity of article-to-be-cleaned)/(specific gravity of particles) is within a range from 0.5 to 3 are preferably adopted as the aforesaid particles. If the aforesaid specific gravity ratio is less than 0.5, the article-to-be-cleaned rises to the top surface of the cleaning layer while being cleaned, whereby the article-to-be-cleaned cannot be uniformly in contact with the cleaning layer thereby raising a fear that uniform cleaning cannot be sufficiently carried out. If the aforesaid specific gravity ratio exceeds 3, the article-to-be-cleaned descends to the bottom surface of the cleaning layer while being cleaned, and in this case as well, the article-to-be-cleaned cannot be uniformly in contact with the cleaning layer thereby raising a fear that uniform cleaning cannot be sufficiently carried out. Further, in each of the ultrasonic cleaning methods according to the present invention, the effect of cleaning the article-to-be-cleaned can be further enhanced if an aqueous solution of a detergent is adopted as the ultrasonic wave transmission medium or if particles having an average particle diameter of 0.1 μm to 500 μm are adopted as the particles.

In the second ultrasonic cleaning method according to the present invention, a cleaning layer formed by mixing particles with a ultrasonic wave transmission medium and a contamination absorbing layer such that a ratio of the particles to the ultrasonic wave transmission medium is lower than in the cleaning layer are used in combination as cleaners. In this cleaning mode, the ultrasonic wave transmission medium performs various movements such as circulating and refluxing between the cleaning layer and the contamination absorbing layer, and functions to absorb contaminating substances dropped in the cleaning layer, thereby further enhancing the effect of peeling off the contaminating substances adhering to the article-to-be-cleaned in the cleaning layer.

### BRIEF DESCRIPTION OF THE DRAWINGS

FIG. 1 is a graph depicting an effect of cleaning an article-to-be-cleaned by the ultrasonic cleaning method according to the present invention;

FIG. 2A is a plan view of an assembly matrix of a piezoelectric unimorph assembly which is an article-to-be-cleaned taken as an object of cleaning in the ultrasonic cleaning method according to the present invention;

FIG. 2B is a plan view illustrating a state of cutting an assembly matrix of a piezoelectric unimorph assembly, which is an article-to-be-cleaned taken as an object of cleaning in the ultrasonic cleaning method according to the present invention, into short strips to obtain a large number of piezoelectric unimorph assemblies;

FIG. 3 is a schematic construction view illustrating one example of a cleaning apparatus for carrying out the ultrasonic cleaning method according to the present invention;

FIG. 4 is a schematic construction view illustrating a cleaning tank for carrying out a conventional ultrasonic cleaning method;

FIG. 5 is a schematic construction view illustrating the first cleaning method for carrying out the ultrasonic cleaning method according to the present invention;

FIG. 6 is a schematic construction view illustrating the second cleaning method for carrying out the ultrasonic cleaning method according to the present invention;

FIG. 7 is a schematic construction view illustrating the third cleaning method for carrying out the ultrasonic cleaning method according to the present invention; and

FIG. 8 is a schematic construction view illustrating the fourth cleaning method for carrying out the ultrasonic cleaning method according to the present invention.

### MODES OF CARRYING OUT THE INVENTION

The present invention relates to a ultrasonic cleaning method such that an article-to-be-cleaned is cleaned with the use of a ultrasonic wave. The aforesaid ultrasonic cleaning method aims at cleaning that is suitable for a small and low-strength article-to-be-cleaned. A ultrasonic wave transmission medium for transmitting a ultrasonic wave to a predetermined region and particles having a larger specific gravity than the ultrasonic wave transmission medium are adopted as cleaners for cleaning the article-to-be-cleaned, and basically these are used in combination.

In the ultrasonic cleaning method according to the present invention, a cleaning layer is formed in which the ultrasonic wave transmission medium and the particles are mixed. A ultrasonic wave is imparted to the aforesaid cleaning layer substantially in a state in which the article-to-be-cleaned is buried in the aforesaid cleaning layer, whereby the ultrasonic wave is transmitted to a particle group, which is mixed in the cleaning layer, via the ultrasonic wave transmission medium to vibrate the particle group in the cleaning layer. Further, in a preferable cleaning mode, as in the second ultrasonic cleaning method according to the present invention, a cleaning layer and a contamination absorbing layer mainly made of a ultrasonic wave transmission medium are used in combination as cleaners.

As the ultrasonic wave transmission medium constituting the cleaning layer and the contamination absorbing layer, a suitable liquid capable of transmitting a ultrasonic wave can be adopted and, although it does not matter whether the cleaning liquid has a cleaning function such as peeling, releasing, or dissolving on a contaminating substance adhering to the article-to-be-cleaned, it is preferable to use a cleaning liquid having a cleaning function. Suitably, one can mention flon-series solvents such as flon or substitute flon, various petrol-series solvents, organic-series solvents such as alcohols or ketones, water such as pure water or super-pure water, detergents made of various surfactants, aqueous solutions of the detergents, and others.

As the particles constituting the cleaning layer, one can adopt various particles of an inorganic series substance, an organic series polymer substance, or the like. As suitable particles, one can mention fine particles of various metals, fine particles of various inorganic oxides, fine particles of various carbides, fine particles of various inorganic nitrides, fine particles of various synthetic resins, and others. Further, the particles to be adopted preferably have an average particle diameter of 0.1 μm to 500 μm. If the average particle diameter of the particles is less than 0.1 μm, there is a fear that the particles themselves may adhere to the article-to-be-cleaned to become a contaminating source, whereas if the average particle diameter of the particles exceeds 500 μm, the number of particles brought into contact with the article-to-be-cleaned will be small, thereby decreasing the cleaning efficiency. Here, with regard to the shape of the particles, rather than particles having a shape like a spherical shape, particles having a shape with a larger number of edge parts are preferable because they have a larger function of scraping the contaminating substance off.

The cleaning layer adopted in each of the ultrasonic cleaning methods according to the present invention is such that the mixing ratio of the particles to the ultrasonic wave transmission medium is from 10 to 60 vol %. Further, the contamination absorbing layer adopted in the second ultrasonic cleaning method according to the present invention is substantially made of a ultrasonic wave transmission medium, and is such that the mixing ratio of the particles to the ultrasonic wave transmission medium is 0.001 vol % or less. Further, as the particles, particles such that a ratio of (specific gravity of article-to-be-cleaned)/(specific gravity of particles) is within a range from 0.5 to 3 are adopted.

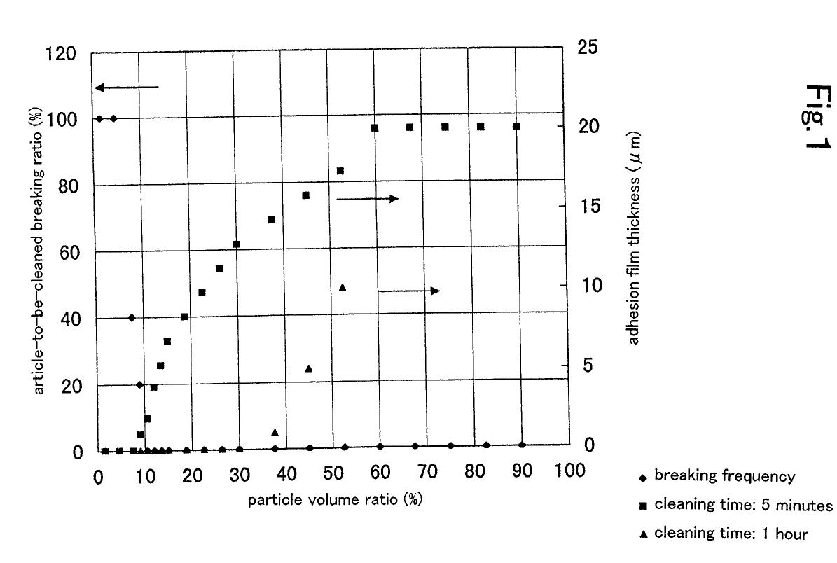

FIG. 1 is a graph depicting a cleaning effect in the case where a ultrasonic cleaning method according to one example of the present invention is carried out. In the graph, the horizontal axis represents the volume ratio (particle volume ratio %) of the particles constituting the cleaning layer to the ultrasonic wave transmission medium; the left vertical axis represents the breaking ratio (article-to-be-cleaned breaking ratio %) showing the ratio of breakage of the article-to-be-cleaned by cleaning; and the right vertical axis represents the cleaning effect (adhesion film thickness μm) after cleaning the article-to-be-cleaned.

For the cleaning layer adopted in the ultrasonic cleaning methods according to the present invention, the effect of the particle volume ratio on the breakage of the article-to-be-cleaned (see the graph of breaking frequency) is as follows. In the range where the particle volume ratio % is within a range less than 10 vol %, according as the particle volume ratio % decreases, the article-to-be-cleaned breaking ratio % increases and, according as the particle volume ratio % approaches 10 vol %, the article-to-be-cleaned breaking ratio % rapidly decreases. When the particle volume ratio % is 10 vol % or more, the article-to-be-cleaned breaking ratio % becomes zero. Further, with regard to the effect of the particle volume ratio on the cleaning of the article-to-be-cleaned (see the graph of cleaning time: 5 minutes and the graph of cleaning time: 1 hour), it goes without saying that the cleaning effect differs depending on the difference of cleaning time; however, when the particle volume ratio % is within a range of 60 vol % or less, the cleaning effect increases according as the particle volume ratio % decreases, and when the particle volume ratio % exceeds 60 vol %, no more cleaning effect can be expected.

In each of the ultrasonic cleaning methods according to the present invention, as the aforesaid particles, it is preferable to adopt particles such that a ratio of (specific gravity of article-to-be-cleaned)/(specific gravity of particles) is within a range from 0.5 to 3 (specific gravity ratio). If the aforesaid specific gravity ratio is less than 0.5, the article-to-be-cleaned rises to the top of the cleaning layer while being cleaned, whereby the article-to-be-cleaned cannot be uniformly in contact with the cleaning layer thereby raising a fear that uniform cleaning cannot be sufficiently carried out. If the aforesaid specific gravity ratio exceeds 3, the article-to-be-cleaned descends to the bottom of the cleaning layer while being cleaned, and in this case as well, the article-to-be-cleaned cannot be uniformly in contact with the cleaning layer thereby raising a fear that uniform cleaning cannot be sufficiently carried out. Here, in the ultrasonic cleaning methods according to the present invention, the effect of cleaning the article-to-be-cleaned can be further enhanced if an aqueous solution of a detergent is adopted as the ultrasonic wave transmission medium or if fine particles having an average particle diameter of 0.1 μm to 500 μm are adopted as the particles.

In each of the ultrasonic cleaning methods according to the present invention, it goes without saying that an article of a high-strength material can be cleaned and cleared; however, an article such as a small single body or structural body is intended. In particular, the method is suitable for a small and low-strength article-to-be-cleaned such as a small single body or structural body made of ceramics that is inferior in breaking strength or breaking toughness, a single body or structural body made of resin, or a small single body or structural body made of metal that is extremely thin or elongate to have a low strength. According to the aforesaid cleaning methods, these low-strength articles can be cleaned without causing damages at the time of cleaning, and the aforesaid articles can be cleaned and cleared well.

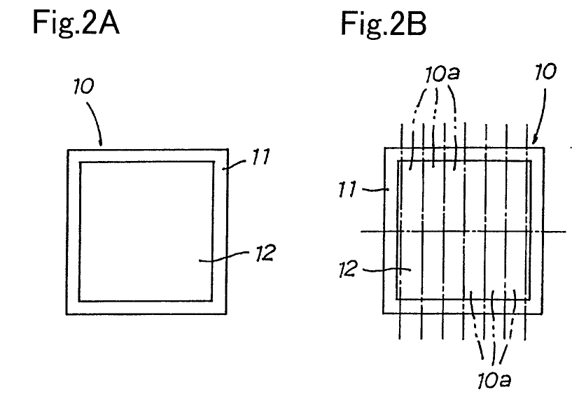

FIGS. 2A and 2B illustrate a piezoelectric unimorph assembly that can be suitably adopted as an article-to-be-cleaned in each of the ultrasonic cleaning methods according to the present invention. The aforesaid piezoelectric unimorph assembly is obtained by cutting an assembly matrix 10 shown in FIG. 2A, which is obtained by bonding a piezoelectric element onto a metal plate via an adhesive, into a large number by the wire-saw processing, as shown in FIG. 2B. In a state of having been cut by the wire-saw processing, each piezoelectric unimorph assembly 10a exhibits a shape with a width of 0.25 mm, a length of 1.9 mm, and a thickness of about 0.2 mm, and is a structural body such that, on one surface of a metal plate 11 (SUS304) with a width of 0.25 mm, a length of 1.9 mm, and a thickness of 0.1 mm, a piezoelectric element 12 (laminate type with a thickness of 75 μm) having the same shape as the metal plate 11 is bonded via an adhesive layer made of a thermosetting epoxy resin or the like and having a thickness of 15 μm. Here, the piezoelectric element 12 is such that two upper and lower surface electrodes having a thickness of 5 μm and a side surface electrode having a thickness of 20 μm are formed on a piezoelectric body. In the aforesaid piezoelectric unimorph assembly 10a, a mixed contaminant of denatured substance of wire-saw cutting oil and abrasive grains adheres to the wire-saw processing surface thereof.

In each of the ultrasonic cleaning methods according to the present invention, the particles are vibrated by transmitting a ultrasonic wave to the particle group via the ultrasonic wave transmission medium constituting the cleaning layer, and the article-to-be-cleaned is cleaned and cleared by using a frictional force and an impinging force caused by the vibration of the particles. In the aforesaid cleaning, the particles allows a suitable frictional force and impinging force to act on the article-to-be-cleaned while mutually restricting their movements in the particle group thereby preventing the kinetic energy from becoming excessively large, and can allow a frictional force and an impinging force suitable for removing the contaminant adhering to the surface of the article-to-be-cleaned to act on the particle-to-be-cleaned without breaking the low-strength article-to-be-cleaned.

The cleaning layer used in each of the ultrasonic cleaning methods according to the present invention is preferably such that a mixing ratio of the particles to the ultrasonic wave transmission medium is from 10 to 60 vol %. If the mixing ratio of the particles is less than 10 vol %, the kinetic energy of the particles caused by the ultrasonic wave becomes too large thereby causing breakage of the article-to-be-cleaned, whereas if the mixing ratio of the particles exceeds 60 vol %, the kinetic energy of the particles caused by the ultrasonic wave becomes too small thereby providing insufficient cleaning of the article-to-be-cleaned.

Further, in the second ultrasonic cleaning method according to the present invention, means is adopted such that a contamination absorbing layer mainly made of a ultrasonic wave transmission medium is positioned above the aforesaid cleaning layer toper form ultrasonic cleaning of the article-to-be-cleaned. In such a cleaning mode, the ultrasonic wave transmission medium performs movements such as circulating and refluxing between the cleaning layer and the contamination absorbing layer so as to absorb contaminating substances dropped in the cleaning layer, thereby further enhancing the effect of peeling off the contaminating substances adhering to the article-to-be-cleaned in the cleaning layer.

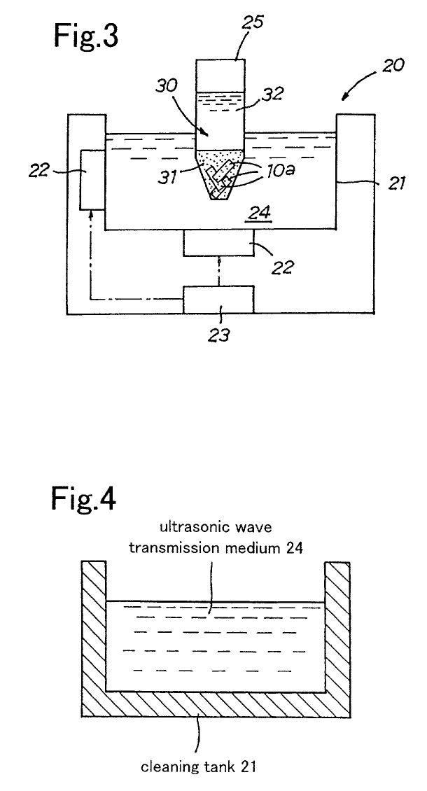

In the ultrasonic cleaning methods according to the present invention, a suitable embodiment can be adopted by using a conventional ultrasonic cleaning machine. FIG. 3 schematically illustrates one example of a cleaning apparatus used for carrying out the ultrasonic cleaning methods according to the present invention. The aforesaid cleaning apparatus 20 is based on a ultrasonic cleaning machine, and is equipped with a cleaning tank 21, a vibrator 22 provided on the outer wall of the cleaning tank 21, and an oscillator 23 that vibrates and operates the vibrator 22, where a ultrasonic wave transmission medium 24 is accommodated in the cleaning tank 21. In the aforesaid cleaning apparatus 20, in a state in which a vessel 25 that accommodates cleaners 30 and an article-to-be-cleaned 10a is generally half-immersed in a ultrasonic wave transmission medium 24 in the cleaning tank 21, the article-to-be-cleaned 10a in the vessel 25 is subjected to ultrasonic cleaning.

In this case, the ultrasonic wave transmission medium 24 accommodated in the cleaning tank 21 need not have a cleaning function at all, so that the ultrasonic wave transmission medium 24 may be a medium capable of transmitting a minute vibration of the vibrator 22 to the cleaners 30 in the vessel 25 well. For example, common water or the like is used as an inexpensive vibration transmitting medium 24. However, the cleaners 30 in the vessel 25 are made of a cleaning layer 31 and a contamination absorbing layer 32; the cleaning layer 31 is constituted with a ultrasonic wave transmission medium such as an aqueous solution of a detergent and a fine particle group such as zirconia powder; and the contamination absorbing layer 32 is substantially constituted with a ultrasonic wave transmission medium such as an aqueous solution of a detergent.

A ultrasonic cleaning method shown in FIG. 3 is one corresponding to the second ultrasonic cleaning method according to the present invention, and performs ultrasonic cleaning in a state in which a vessel 25 accommodating the cleaners 30 and an article-to-be-cleaned 10a is stationary by adopting the above-mentioned cleaning apparatus 20. The vessel 25 is preferably a vessel having a test tube shape with a generally thin vessel shape and a large specific surface area so that the ultrasonic wave sufficiently reaches the cleaners 30 in the vessel 25.

However, if means is adopted such that the cleaners 30 and the article-to-be-cleaned 10a uniformly pass through a site of strong ultrasonic wave by slowly and moderately stirring the cleaners 30 and the article-to-be-cleaned 10a accommodated in the vessel 25, a generally thick vessel having a small specific surface area, for example, a vessel having a beaker shape or a wide-mouthed bottle shape can be adopted as the vessel 25, or alternatively the cleaning tank 21 itself in the cleaning apparatus 20 can as well be used as the vessel.

FIG. 4 shows a cleaning tank of a conventional cleaning apparatus for comparison. The aforesaid cleaning tank 21 accommodates a ultrasonic wave transmission medium 24; however, a cleaning liquid is adopted as this ultrasonic wave transmission medium 24, and the article-to-be-cleaned is subjected to ultrasonic cleaning by being directly immersed in the ultrasonic wave transmission medium 24. Therefore, the ultrasonic cleaning method according to the present invention is clearly a cleaning method of a completely different system from the conventional ultrasonic cleaning method in that the ultrasonic cleaning method according to the present invention does not use the ultrasonic wave transmission medium 24 as a cleaning liquid.

In the case where the ultrasonic cleaning method according to the present invention is to be carried out, adoption of means for slowly and moderately stirring the cleaners and the article-to-be-cleaned accommodated in the vessel provides an advantage such that a large amount of article-to-be-cleaned can be subjected to a cleaning process at a time.

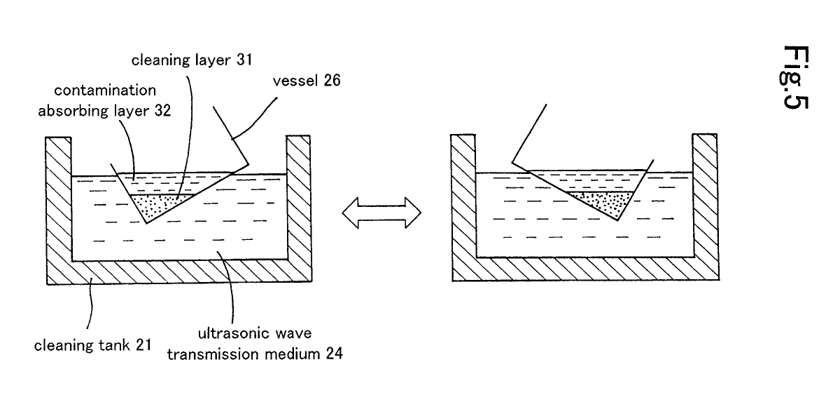

As the means for stirring the cleaners and the article-to-be-cleaned accommodated in the vessel, one can adopt means for directly stirring the cleaners and the article-to-be-cleaned by using a stirring blade. Further, one can adopt means for stirring the cleaners and the article-to-be-cleaned in the vessel by allowing rotation, swinging, or the like of the vessel that is in a state in which the cleaners and the article-to-be-cleaned are accommodated. However, from the view point of preventing damages of the article-to-be-cleaned, it is preferable to adopt the latter means, namely, means for stirring the cleaners and the article-to-be-cleaned in the vessel by allowing rotation, swinging, or the like of the vessel that is in a state in which the cleaners and the article-to-be-cleaned are accommodated. FIGS. 5 to 8 schematically illustrate a plurality of means for stirring the cleaners and the article-to-be-cleaned accommodated in the vessel.

The stirring means in the cleaning apparatus shown in FIG. 5 is means for stirring the cleaners and the article-to-be-cleaned accommodated in the vessel 26 by swinging the vessel 26 forward, backward, rightward, and leftward, as illustrated in FIG. 5, in a state in which a part of the vessel 26 accommodating the cleaners and the article-to-be-cleaned is immersed in the ultrasonic wave transmission medium 24 in the cleaning tank 21. A vessel having a beaker shape is adopted as the vessel 26.

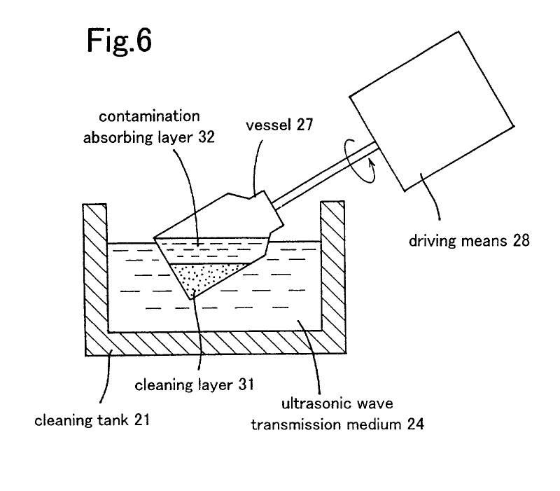

The stirring means in the cleaning apparatus shown in FIG. 6 is means for stirring the cleaners and the article-to-be-cleaned accommodated in the vessel 27 by immersing a part of the vessel 27, which accommodates the cleaners and the article-to-be-cleaned, in the ultrasonic wave transmission medium 24 in the cleaning tank 21 in a tilted state, and rotating the vessel 27 by driving means made of an electric motor 28. A vessel having a wide-mouthed bottle shape is adopted as the vessel 27.

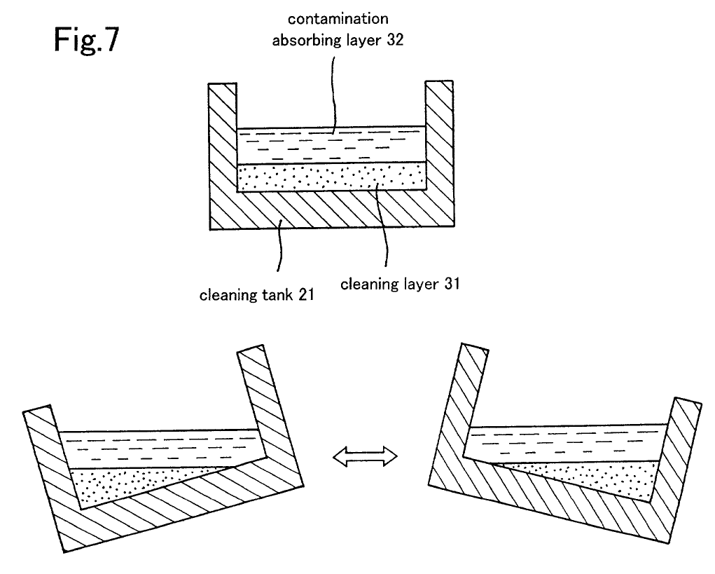

The stirring means in the cleaning apparatus shown in FIG. 7 is means for stirring the cleaners and the article-to-be-cleaned accommodated in the cleaning tank 21 by directly accommodating the cleaners and the article-to-be-cleaned in the cleaning tank 21 and swinging the cleaning tank 21 forward, backward, rightward, and leftward in a state in which the cleaners and the article-to-be-cleaned are accommodated in the cleaning tank 21.

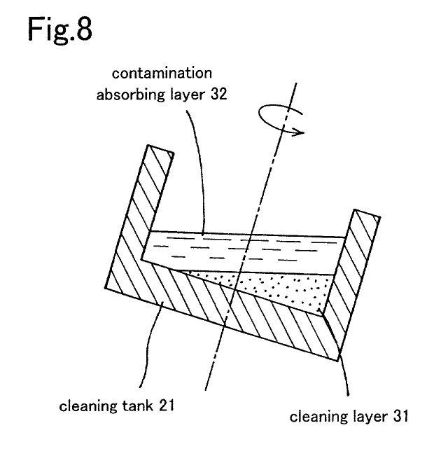

The stirring means in the cleaning apparatus shown in FIG. 8 is means for stirring the cleaners and the article-to-be-cleaned accommodated in the cleaning tank 21 by directly accommodating the cleaners and the article-to-be-cleaned in the cleaning tank 21 and rotating the cleaning tank 21 while swinging the cleaning tank 21 forward, backward, rightward, and leftward in a state in which the cleaners and the article-to-be-cleaned are accommodated in the cleaning tank 21.

Embodiment

In the present embodiment, an experiment was conducted to perform ultrasonic cleaning of a piezoelectric unimorph assembly, which is a small structural body made of ceramics and being inferior in the breaking strength and in the breaking toughness, by adopting the ultrasonic cleaning method according to the present invention. Further, along with this, an experiment was conducted to perform ultrasonic cleaning of a piezoelectric unimorph assembly, which had been cut out from the same assembly matrix, by adopting the conventional ultrasonic cleaning method described in the beginning, as a comparison example.

Article-to-be-cleaned: It is a piezoelectric unimorph assembly 10a obtained by cutting an assembly matrix 10 of the piezoelectric unimorph assembly by the technique shown in FIG. 2, and is one such that, on one surface of a metal plate (SUS304) with a width of 0.25 mm, a length of 1.9 mm, and a thickness of 0.1 mm, a laminate-type piezoelectric element having the same shape as the metal plate and having a thickness of 75 μm is bonded via an adhesive layer made of a thermosetting epoxy resin or the like and having a thickness of 15 μm. Here, the piezoelectric element is such that two upper and lower surface electrodes having a thickness of 5 μm and a side surface electrode having a thickness of 20 μm are formed on a piezoelectric body.

As the article-to-be-cleaned, the aforesaid piezoelectric unimorph assembly 10a is given as a representative example; however, in addition to this, piezoelectric unimorph assemblies having different strengths are also adopted, namely, piezoelectric unimorph assemblies having the same construction in which metal plates (SUS304) having thicknesses of 0.005 mm, 0.01 mm, 0.05 mm, 0.2 mm, and 0.5 mm are adopted. In the experiment of ultrasonic cleaning, 10 pieces of piezoelectric unimorph assemblies 10a having a metal plate with the same thickness were subjected to ultrasonic cleaning as one group. In these piezoelectric unimorph assemblies 10a, a mixture of a denatured substance of wire-saw cutting oil and abrasive grains adheres to the wire-saw processing surface as a contaminant.

Cleaning apparatus: In the experiment of ultrasonic cleaning, a cleaning apparatus 20 shown in FIG. 3 is adopted in each of the cleaning experiments according to the embodiment and according to the comparison example. In each of the cleaning experiments according to the embodiment, a vessel 27 (capacity of 250 ml) made of pyrex glass and having a wide-mouthed bottle shape was adopted as the vessel; the cleaners 30 and the piezoelectric unimorph assembly 10a constituting the article-to-be-cleaned were accommodated in the vessel 27; and the ultrasonic cleaning experiment was conducted by the technique using the driving means 28 shown in FIG. 6. Further, in each of the cleaning experiments according to the comparison example, a cleaning apparatus having a cleaning tank 21 shown in FIG. 4 was adopted, and the experiment of ultrasonic cleaning was conducted by immersing the piezoelectric unimorph assembly 10a constituting the article-to-be-cleaned in a cleaning liquid, which is the ultrasonic wave transmission medium 24, accommodated in the cleaning tank 21.

Cleaner (embodiment): The cleaner is a cleaning agent used for collectively cleaning ten pieces of piezoelectric unimorph assemblies 10a constituting the article-to-be-cleaned. In each cleaning experiment according to the embodiment, zirconia powder (trade name: GRAIN^{...}made by NGK Insulators, Ltd.) having an average particle diameter within the range from 0.1 μm to 500 μm was adopted as the particles which are the constituent substance of the cleaner 30; a 3% aqueous solution of a neutral detergent (aqueous solution of detergent) was adopted as the ultrasonic wave transmission medium; and the cleaner 30 having a construction such that the lower layer is the cleaning layer 31 and the upper layer is the contamination absorbing layer 32 was prepared by adding and mixing 60 g of zirconia powder into 90 ml of the aqueous solution of detergent constituting the ultrasonic wave transmission medium accommodated in the vessel 27.

The cleaning layer 31 of the cleaner 30 is such that the mixing ratio of the zirconia powder to the aqueous solution of detergent is within the range from 10 to 60 vol %, and the contamination absorbing layer 32 is substantially made of the aqueous solution of detergent where the mixing ratio of the zirconia powder to the aqueous solution of detergent is 0.001 vol % or less. The zirconia powder adopted as the particles is, in relation to each piezoelectric unimorph assembly 10a, such that the ratio of (specific gravity of article-to-be-cleaned)/(specific gravity of fine particles) is within the range from 0.5 to 3. Here, in each of the cleaning experiments according to the embodiment, commercially available water is adopted as the ultrasonic wave transmission medium 24 accommodated in the cleaning tank 21 of the cleaning apparatus 20.

Cleaner (comparison example): The aforesaid cleaner also is used for collectively cleaning ten pieces of piezoelectric unimorph assemblies 10a constituting the article-to-be-cleaned, and is such that fine particles are uniformly dispersed in a cleaning liquid. In each of the cleaning experiments according to the comparison example, 0.5 μm α-alumina powder (made by Wako Pure Chemicals Co., Ltd.) were adopted as the particles which are the constituent substance of the cleaner; a 3% aqueous solution of a neutral detergent (aqueous solution of detergent) was adopted as the cleaning liquid; and a cleaner (cleaning liquid) in which the α-alumina powder is uniformly dispersed within the range from 0.01 to 5 wt % was prepared by adding the α-alumina powder into the aqueous solution of detergent (ultrasonic wave transmission medium 24) accommodated in the cleaning tank 21 shown in FIG. 4.

Cleaning process: In each of the cleaning experiments according to the embodiment, the vessel 27 accommodating the cleaner 30 and the piezoelectric unimorph assemblies 10a was set, as shown in FIG. 6, in the ultrasonic wave transmission medium 24 accommodated in the cleaning tank 21; a ultrasonic wave of 28 kHz was radiated while rotating the aforesaid vessel 27 at 30 rpm; and, in this state, the ultrasonic cleaning was carried out for each period of time. In each of the cleaning experiments according to the comparison example, the cleaner and the piezoelectric unimorph assemblies 10a were accommodated in the cleaning tank 21 shown in FIG. 4, a ultrasonic wave of 28 kHz was imparted to the cleaner and the piezoelectric unimorph assemblies 10a; and the ultrasonic cleaning was carried out for each period of time. In these cleaning processes, the ultrasonic wave of 28 kHz is given as a representative example; however, cleaning experiments were conducted in a frequency range from higher frequency to lower frequency with a center at the ultrasonic wave of 28 kHz.

The piezoelectric unimorph assemblies 10a cleaned in each of these cleaning experiments according to the embodiment and according to the comparison example were subjected to observation of a contaminated state by using an optical microscope, and in the cleaning experiment according to the embodiment, the state of particle dropping was measured in the piezoelectric unimorph assemblies 10a after cleaning. Prior to the measurement of the state of particle dropping, the piezoelectric unimorph assemblies 10a after cleaning were put into a beaker that accommodates a super-pure water; the aforesaid beaker was set into a ultrasonic cleaning machine; and a cleaning process of radiating a ultrasonic wave of 100 kHz for ten minutes was carried out. Thereafter, 5 ml of the super-pure water in the beaker was collected, and means was adopted to measure the number of particles therein with a particle counter.

In each of the cleaning experiments, after the cleaning was finished, the contents in the vessel 27 or the contents in the cleaning layer 21 were put onto a mesh to separate the piezoelectric unimorph assemblies 10a by allowing the cleaners to pass through the mesh; the piezoelectric unimorph assemblies 10a subjected to the separation process were subjected to a clearing cleaning process that performs ultrasonic cleaning in water or in a solvent; and the cleared piezoelectric unimorph assemblies 10a were supplied as a sample for observation with an optical microscope.

(Cleaning effect): In the cleaning experiment (28 kHz ultrasonic wave, 10 minutes) of piezoelectric unimorph assembly 10a (thickness of metal plate: 0.1 mm) which is a representative example among the cleaning experiments of the embodiment, no damage occurred at any site in the piezoelectric unimorph assembly 10a, and the contaminant could be completely removed. Further, a metal luster, which was not seen before cleaning, was recognized. Furthermore, the measurement of the state of particle dropping showed that, although the number of particles of 0.5 μm or more was 100,000/5 ml or more before cleaning, the number greatly decreased to less than 10,000/5 ml.

Further, in the cleaning experiments of piezoelectric unimorph assemblies 10a with metal plates having thicknesses of 0.005 mm, 0.01 mm, and 0.05 mm among the cleaning experiments of the embodiment, when cleaning was carried out for 7 minutes with a ultrasonic wave of 28 kHz, no damage occurred at any site in the piezoelectric unimorph assemblies 10a with metal plates having thicknesses of 0.01 mm, and 0.05 mm, and the contaminant could be completely removed.

On the other hand, in the cleaning experiment (frequency of 28 kHz, 10 minutes) of all the piezoelectric unimorph assemblies 10a with metal plates having different thicknesses among the cleaning experiments of the comparison example, the contaminant could not be completely removed, and also a damage was recognized at each site of the piezoelectric unimorph assemblies 10a. For example, deformation of the metal plate constituting the piezoelectric unimorph assembly, generation of cracks in the piezoelectric element caused by the deformation of the metal plate, peeling off at the joining interface between the metal plate and the piezoelectric element, and others were recognized.

Further, in the cleaning experiment of the piezoelectric unimorph assemblies 10a with metal plates having thicknesses of 0.2 mm and 0.5 mm among the cleaning experiments of the comparison example, when cleaning was carried out for 4 minutes at a frequency of 28 kHz, the contaminant could be completely removed. In this case, no deformation was recognized in the metal plate constituting the piezoelectric unimorph assemblies 10a, and only a slight decrease was recognized at a part of the upper electrode constituting the piezoelectric element.

What is claimed is:

1. A ultrasonic cleaning method that performs ultrasonic cleaning of an article-to-be-cleaned by a combination of a ultrasonic wave transmission medium transmitting a ultrasonic wave to a predetermined region and particles having a larger specific gravity than the ultrasonic wave transmission medium, said ultrasonic cleaning method being characterized in that said article-to-be-cleaned is cleaned by allowing at least a part of the article-to-be-cleaned to be in contact with a cleaning layer formed with said ultrasonic wave transmission medium and said particles where the mixing ratio of the particles to said ultrasonic wave transmission medium is 10 to 60 vol %, and imparting a ultrasonic wave to the cleaning layer.

2. A ultrasonic cleaning method that performs ultrasonic cleaning of an article-to-be-cleaned by a combination of a ultrasonic wave transmission medium transmitting a ultrasonic wave to a predetermined region and particles having a larger specific gravity than the ultrasonic wave transmission medium, said ultrasonic cleaning method being characterized in that a cleaning layer formed with said ultrasonic wave transmission medium and said particles, and a contamination absorbing layer such that a ratio of said particles to said ultrasonic wave transmission medium is lower than in said cleaning layer are adopted as cleaners, and said article-to-be-cleaned is cleaned by allowing at least a part of the article-to-be-cleaned to be in contact with said cleaning layer of the cleaners, and imparting a ultrasonic wave to the cleaning layer.

3. The ultrasonic cleaning method according to claim 2, characterized in that a mixing ratio of said particles to said ultrasonic wave transmission medium in said cleaning layer is 10 to 60 vol %.

4. The ultrasonic cleaning method according to claim 2, characterized in that a mixing ratio of said particles to said ultrasonic wave transmission medium in said contamination absorbing layer is 0.001 vol % or less.

5. The ultrasonic cleaning method according to claim 1, 2, 3, or 4, characterized in that particles such that a ratio of (specific gravity of article-to-be-cleaned)/(specific gravity of particles) is within a range from 0.5 to 3 are adopted as said particles.

6. The ultrasonic cleaning method according to claim 1, 2, 3, 4, or 5, characterized in that said particles are particles of an inorganic series substance or an organic series polymer substance, and said ultrasonic wave transmission medium is a cleaning liquid.

7. The ultrasonic cleaning method according to claim 1, 2, 3, 4, 5, or 6, characterized in that said particles are particles having an average particle diameter of 0.1 μm to 500 μm.
